(19) United States
(12) Patent Application Publication
(10) Pub. No.: US 2007/0063508 A1
(43) Pub. Date: Mar. 22, 2007

(54) Joint infill cladding and method of applying same

(75) Inventor: Guy G. Gronquist, Katy, TX (US)

Correspondence Address: ALBERT B. KIMBALL, JR.;BRACEWELL & PATTERSON L L P, 711 LOUISANA SUITE 2300, HOUSTON, TX, 77002, US

(73) Assignee: Offshore Joint Services, Inc., Katy, TX (US)

(21) Appl. No.: 11/231,449

(22) Filed: Sep. 21, 2005

(51) Int. Cl. F16L 47/00; F16L 53/00

(52) U.S. Cl. 285/294.2; 285/294.1; 285/41

(57) ABSTRACT

A protective sleeve is applied as a permanent outer cladding shield over a joint infill at the welded end portions of adjacent coated sections of pipe for a pipeline in or beneath a body of water. The sleeve once installed forms a seal against entry of water to protect the pipe from corrosion. The sleeve takes the form of a sheet of synthetic resin mounted to form a cylinder about the area to receive the joint infill. An electrically conductive mesh or wire element mounted with the sheet is provided with electrical current to fuse circumferential portions of the sleeve to the weight-coated cover sections of the pipe and to fuse longitudinal portions of the sleeve together. A seal against entry of water is formed between the sleeve and the pipe covering. A port formed in the sleeve allows introduction of the joint infill. A closure is later hermetically sealed to the sleeve over the injection port by electrical heating of conductive elements mounted on a surface of the closure.

### CROSS-REFERENCE TO RELATED APPLICATIONS

The present application relates to joint infill cladding of pipeline joints, as does commonly owned U.S. patent application Ser. No. ______ entitled “Joint Infill Cladding Applicator Clamp” (Attorney Docket No. 085356.000023), filed of even date herewith, and of which applicant is inventor.

### FIELD OF THE INVENTION

The present invention relates generally to providing water impenetrable outer cladding, and to methods of installing such cladding, to outer pipeline coatings to better protect of joint infill coatings applied to exposed ends of coated pipeline to be laid in bodies of water.

### BACKGROUND

It is conventional in the offshore pipeline industry to use weighted coated pipe on pipelines which are being laid on or under the floors of bodies of water. Originally, the weight coatings of each section or length of pipe were of concrete with end metal portions of the pipe left bare or unprotected. The end portions of adjacent lengths of pipe were welded together on a pipe laying barge as the pipeline was being formed. The bare metal was then covered with a film or sheet of corrosion resistant material. A joint infill resulting from injection of chemicals which reacted and formed an open cell polyurethane foam was then used to fill the annular socket or space between weight coatings. U.S. Pat. Nos. 5,900,195 and 6,402,201, each commonly owned by the assignee of the present application, are examples of this open cell foam infill technology.

More recently, the pipe lengths have been weight coated with a solid synthetic resin, usually being polypropylene and polyethylene synthetic resin coatings to serve as thermal insulation. This has been increasingly the case as offshore production has moved into deeper portions of bodies of water. In some cases a concrete weight coating has been applied on top of the synthetic resin insulation. A similar solid synthetic resin was also desired for the joint infill material. Solid synthetic resins are impenetrable by water; however, concerns have been raised about water ingress through even the relatively small spaces or gaps between the joint infill and the synthetic resin insulation coatings. This has been a particular concern due to the increased hydrostatic pressures beneath bodies of water, particularly in deeper bodies of water.

Other patents, such as U.S. Pat. No. 6,059,319, were directed to forming a cylindrical sleeve seal over the gap between adjacent lengths of plastic coated pipe. Filler panels of butyl rubber, bitumastic, rubberized bitumen or similar materials of a size approximating the interior space within the cylindrical sleeve were used in an attempt to provide corrosion protection. However, gaps and spaces were often present between the various elements, such as between the filler panel material, the pipe coating and the cylindrical sleeve seal. There was thus a risk of fluid leakage and corrosion. For offshore pipelines, particularly in deeper bodies of water, the hydrostatic pressures increased the concerns of fluid leakage through these gaps and spaces and resulting possible corrosion.

### SUMMARY OF THE INVENTION

Briefly, the present invention provides a new and improved method of applying a protective outer cladding welded to the factory synthetic resin coatings over end portions of adjacent coated sections of pipe for a pipeline. A sheet of synthetic resin with an electrically conductive element about at least three sides is applied to form a cylindrical sleeve about the welded end portion. The electrically conductive element is connected to a source of electrical current. Chemical components are introduced into the interior of the cylindrical sleeve to allow a synthetic resin to form and fill the interior of the sleeve as joint infill insulation between the adjacent pipe sections. Electrical current is then sent into the electrically conductive element to heat adjacent portions of the cylindrical sleeve to bond the sheet together with the weight coating and to seal the sleeve over the joint infill coating. The present invention also provides a new and improved protective shield over joint infill on coated pipe sections for a pipeline. The coated sections may include insulation coating and weight coating.

The synthetic resin portions of the pipeline in a preferred embodiment are coated with a synthetic resin weight coating, and the synthetic resin formed during the step of introducing components is preferably a solid polyurethane which bonds with the synthetic resin coating along the length of the pipe.

To better understand the characteristics of the invention, the description herein is attached, as an integral part of the same, with drawings to illustrate, but not limited to that, described as follows.

### BRIEF DESCRIPTION OF THE DRAWINGS

A better understanding of the present invention can be obtained when the detailed description set forth below is reviewed in conjunction with the accompanying drawings, in which:

FIG. 1 is an isometric view of a joint infill cover sleeve with an electrical heating/welding element according to the present invention.

FIG. 2 is an enlarged isometric view of the sleeve of FIG. 1.

FIGS. 3 and 4 are views of a sleeve according to the present invention being applied to a simulated pipe joint.

FIGS. 5 and 6 are views of the sleeve of FIGS. 3 and 4 with electric leads applied and being secured in place.

FIG. 7 is a view of joint infill material being injected within a port in the sleeve of FIGS. 5 and 6.

FIGS. 8 and 9 are views of a seal being installed over the injection port shown in FIG. 7.

FIGS. 10, 11, 12 and 13 are views of a completed joint infill shield according to the present invention.

FIG. 14 is a view of an electric power source for current applied through electrical leads to heating/welding elements to form the joint infill shield according to the present invention.

To better understand the invention, a detailed description of some of the modalities, as shown in the drawings for illustrative but not limiting purposes, is included as part of the description herein.

### DETAILED DESCRIPTION

Although the following detailed description contains many specific details for purposes of illustration, anyone of ordinary skill in the art will appreciate that many variations and alterations to the following details are within the scope of the invention. Accordingly, the exemplary embodiment of the invention described below is set forth without any loss of generality to, and without imposing limitations thereon, the claimed invention.

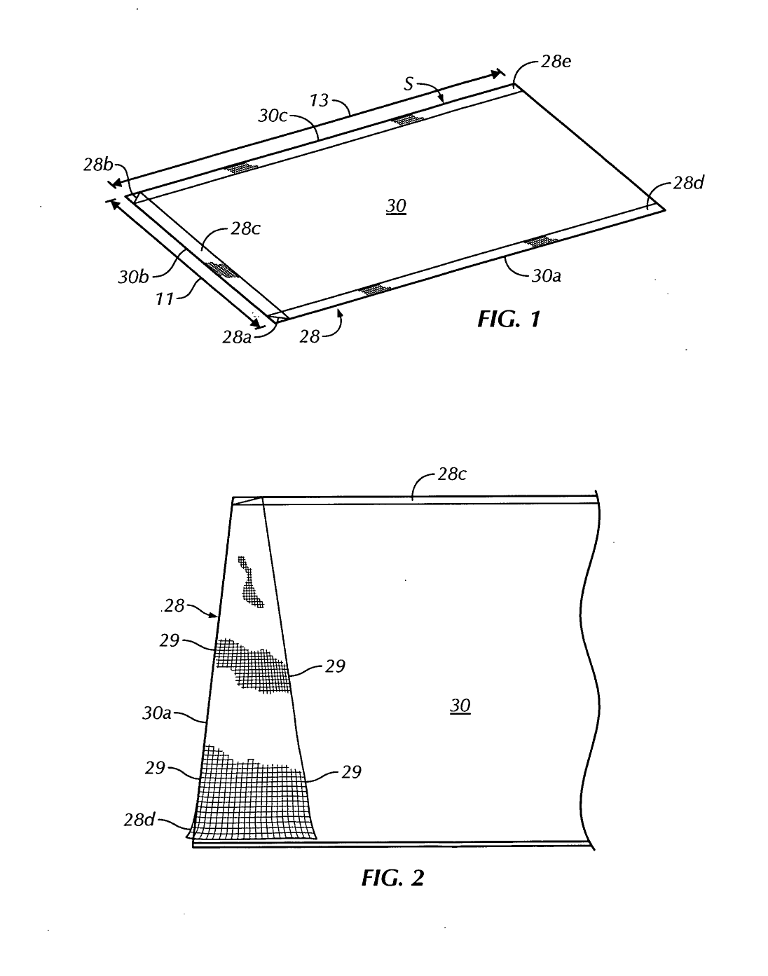

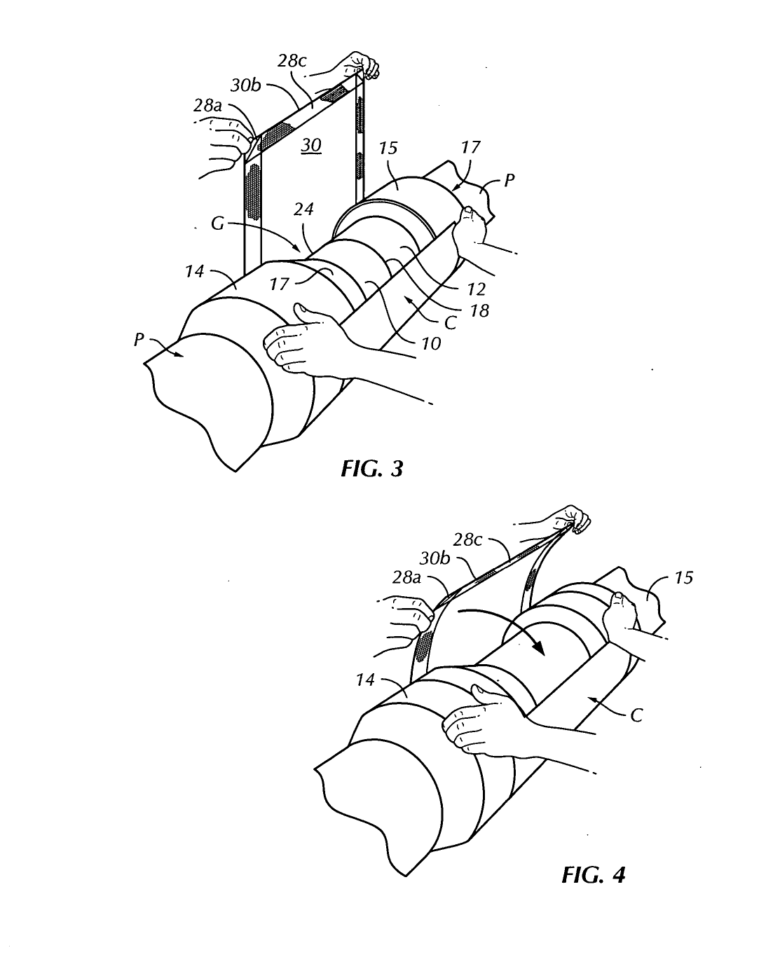

In the drawings, FIGS. 1 and 2 show a flat rectangular sheet S formed of a suitable synthetic resin, such as polypropylene or polyethylene. The synthetic resin material of the sleeve S has a typical thickness from about 0.125″ to 0.5″ or larger which is wrapped into a cylindrical sleeve in order to be applied as protective cladding in conjunction with join infill on coated sections of a pipeline. The dimensions of the sleeve S are such that it extends as indicated at 11 laterally a sufficient distance to span a gap G (FIG. 3) at welded end portions 10 and 12 of the pipeline P. The welded end portions or stubs 10 and 12 are located between coatings 14 and 15 which form selected coated sections 16 and 17 of the pipeline P. The dimensions of the sheet S are also such that it extends laterally or transversely as indicated at 13 a sufficient distance to circumferentially enclose the gap G (FIGS. 3 and 4) with adequate overlap of portions of the wrapped sheet S to allow sealing according to the present invention.

According to the present invention, sheet S is wrapped about the pipeline P form a cylindrical sleeve C (FIGS. 3 and 4) which is a protective outer cladding shield over a weld joint 18 formed between the welded end portions 10 and 12 adjacent the coated pipe sections 16 and 17 of the pipeline P. The coatings 14 and 15 applied to the pipeline are a suitable, fluid impenetrable, hard, high-density synthetic resin such as a high-density polypropylene or polyethylene, also known as HDPP or HDPE, respectively. It should be understood that, if described, a number of other water impenetrable resins may be used in place of HDPP or HDPE. The coatings 14 and 15 are factory applied and serve to provide thermal insulation for the fluids transported through the pipeline. If desired, an outer weight coating of concrete may be applied as a weight coating as a part of coatings 14 and 15 on top of the thermal insulative HDPE or HDPP.

As is conventional, the end portions 10 and 12 of the pipe sections 16 and 17 are welded together to form the weld joint 18. The exposed end or stub portions 10 and 12 of the pipe sections 16 and 17, respectively, in the area of the gap G are not weight coated prior to the welding of sections 10 and 12 together. If desired, a thin corrosion protective coating may be installed over the end portions 10 and 12 after the weld joint 18 is formed and the weld area and end portions cleaned.

As will be set forth below, the sheet S is formed into the cylindrical sleeve C, and then an annulus or cylindrical space 24 is formed about the exposed pipe sections 10 and 12 adjacent the weld joint 18. The annulus 24 is preferably filled such as by pouring, injection or the like with a chemical composition such as a suitable synthetic resin, in the form of a polyurethane or epoxy which sets or hardens in the annulus to form a HDPE or other hard synthetic resin infill I. As an alternative, chemical components which mix and then harden to form a hard polyurethane or epoxy joint infill I for insulation may be injected into the annulus 24. The composition or components which form the joint infill I also bond with the adjacent weight coatings 14 and 15 of the pipeline P and also with synthetic resin interior surface portions 30 of the sleeve S. Due to such bonding, no flow path for water ingress is formed between the end portions 10 and 12 adjacent weld joint in the pipeline P.

As shown in FIGS. 1 and 2, a continuous U-shaped strip or band 28 of a welding element/mesh is folded at corners 28a and 28b to conform its U-shape to the three edges 30a, 30b and 30c of the sheet S. The welding element 28 is pre-attached, such as by means of tack welding, at a number of spaced locations 29 (FIG. 2), along the three edges 30a, 30b and 30c on the periphery of the interior surface 30 of the sheet S. The U-shaped welding element 28 is formed of a suitable conductive metallic material, such as a number of alloys including stainless steel, nickel-chromium, aluminum, copper, copper-tin, or other electrically conductive material. It should be understood that the foregoing materials for the welding element 28 are given by way of example, and that others may be used, if desired.

The welding element 28 in response to the flow of electrical current heats and melts the adjacent synthetic resin materials. The heated, melted synthetic resin bonds overlapping or adjacent portions of the cylindrical sleeve C together and also to the weight coatings 16 and 17. End portions 30a and 30c of the sleeve C are disposed circumferentially. When the sleeve S is formed into the cylindrical sleeve C and heated by welding element 28, the end or edge portions 30a and 30c provide circumferential bonding together of the coiled cylindrical portions of the sheet S at each end of the annulus 24. The circumferential end portions 30a and 30c also bond the sleeve S circumferentially to the coated portions 16 and 17, respectively.

A central portion 28c of the conductive heat strip 28 adjacent the edge 30b of the sleeve C forms a longitudinal seal L along an area of longitudinal overlap along edge portion 30b. The circumferential seals L are formed between the sleeve S and the weight coated portions 16 and 17 at each end of the gap G. The longitudinal seal L formed in the sleeve S extends between the circumferential seals to seal the gap G.

Electrical conductive contacts or leads 32 and 34 are installed or attached to connect the conductive strip or band 28 to a power supply P (FIG. 14) so that electrical current may be provided from the power supply P to the conductive strip welding element or band 28. The leads 32 and 34 are installed or attached to make contact on opposite end portions 28d and 28e of the welding element 28 near the beginning and end of its U-shape. In some instances, the electrical conductive leads 32 and 34 are formed to be connected with the conductive strip or band, as shown in FIG. 1. As an alternative, removable conductive probes or contacts separately insertable and removable may be used.

The end portions 28d and 28e are located when the cylindrical sleeve C is formed, on opposite sides of the annulus 24, with the longitudinal portion 28c of the U-shape extending longitudinally between adjacent overlapping portions of the cylindrical sleeve C. In this manner, the synthetic resin bond or weld formed when element 28 heats due to electrical current flow is one continuous synthetic resin bond from one end to the other end of the sleeve C. The bond so formed is located circumferentially at end portions 28d and 28e connected around two corners 28a and 28b to form the longitudinal weld

Sizes of the sleeve C can vary to accommodate pipe sizes for example, 2″ thru 60″ diameters. The sleeve C in most cases is preferably pre-abraded on the inside surface 30. If desired, it may be factory corona-treated, or treated in the field by means of flame treatment, or both, to enhance the bond at the interface of the inside of the sleeve C with the solid polyurethane infill I that is formed in the annulus 24.

FIGS. 3 and 4 illustrate initial parts of the joint infill protective sleeve application process of the present invention. The sheets are applied by hand as shown, or by machine to the field joint configuration of the pipeline P in a cylindrical wrap manner to the coated pipe sections 16 and 17. Typically, weight coatings 14 and 15 are either polypropylene or polyethylene. However, it should be understood that other suitable strength and density synthetic resin may be used as factory pipeline coatings 14 and 15. The sleeve S is preferably also manufactured of the same or very similar synthetic resin material as the factory coatings 14 and 15 on the pipeline.

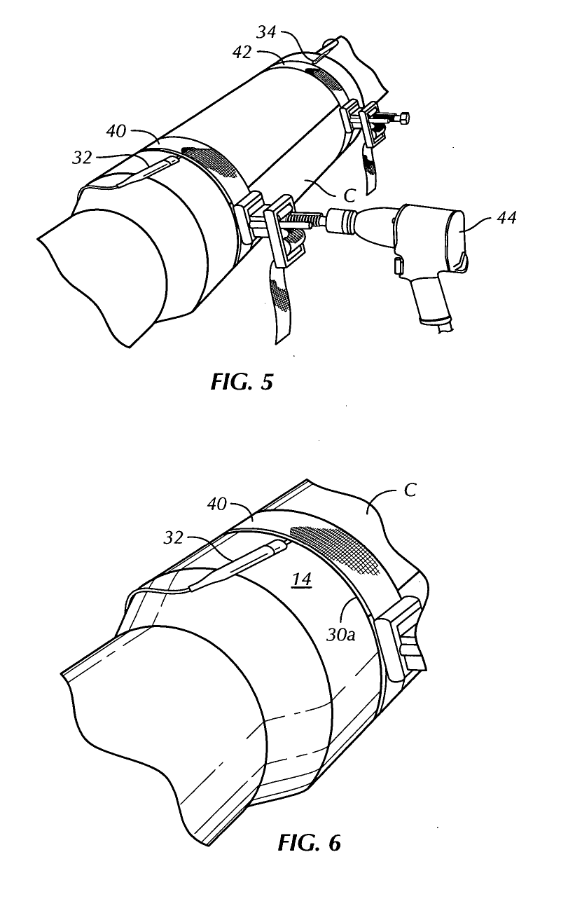

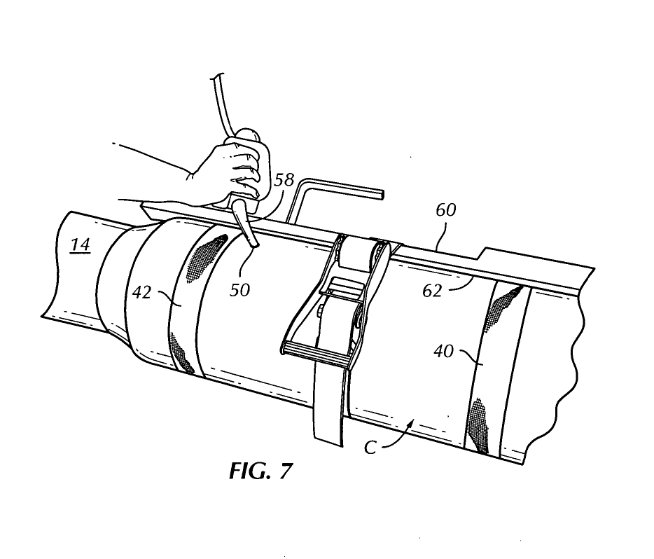

FIGS. 5 and 6 show the cylindrical sleeve C being secured in place using mechanical band straps 40 and 42. At the same time, the electric welding leads 32 and 34 are installed under the welding element/mesh or band 28 on the ends 28d and 28e to make contact where the welding element 28 begins and ends. The circumferential band straps 40 and 42 are placed directly on top of the areas of the sleeve C to be circumferentially welded to the factory coatings 14 and 15. The mechanical band straps 40 and 42 can be secured with any of several conventional band-tensioning mechanisms. For example, a screw-type, air impact wrench 44 operated with a regulator to ensure consistent pressure may be used for this purpose. Alternatively, the band straps 40 and 42 can be secured in place with hydraulic clamps adjustable by means of using hydraulic flow meters also to ensure consistent pressure. Other band tensioning mechanisms may also be used, if desired.

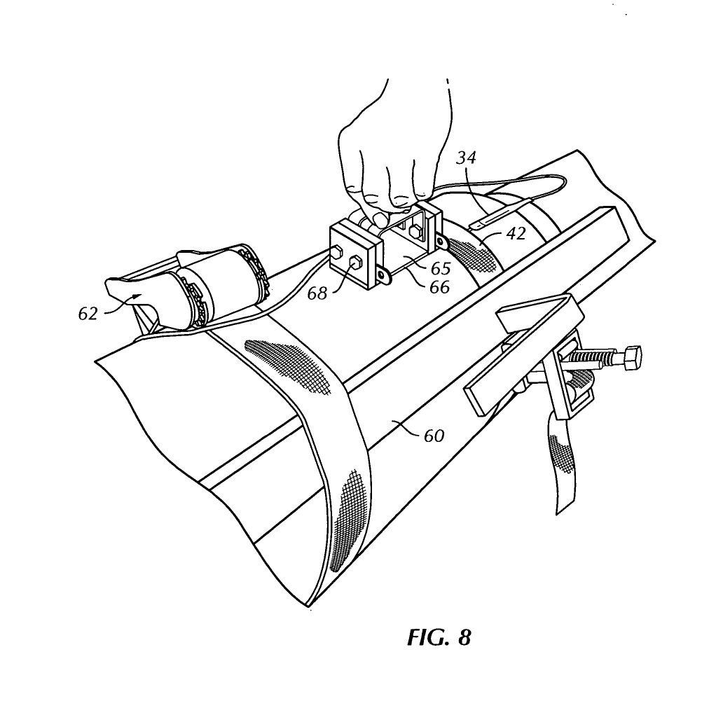

FIG. 7 shows an injection port 50 which is drilled or otherwise formed in the sleeve C, for example at the job site. In FIG. 7, the port 50 is shown as located in the top center of the sleeve C just next to the cutback or edge of the factory applied weight coating 16 or 17 at a high or uppermost location on the circumference of the weight coating. It should be understood that the injection or infill inlet port 50 may be located at other positions on the sleeve C, if desired. For example, in some situations it may be desirable to locate the port 50 at the bottom center or other lower position of the sleeve C. An example of this type could be when the infill is an elastomer being infilled into the annulus 24 from a bottom or lower position. As an alternative feature, the injection port 50 may be pre-formed in the sheet S at a suitable location before delivery to the job site. It is also possible in some cases for the annulus 24 to be filled from the bottom through a pre-drilled and/or threaded injection port at the bottom of the cylindrical sleeve C.

A solid polyurethane-forming material 55 is pumped or poured into the annulus 24 with a hose and nozzle 58 until the volume of the annulus 24 is full. The solid polyurethane material 55 quickly reacts and changes state from liquid to solid, hardening and forming the fluid impenetrable joint infill I. In most cases the polyurethane material 55 used has no expansion on exposure to air. However, in some cases the infill material 55 may be of a lower density that does expand somewhat. The polyurethane materials used for this application may range in density from 2 to 80 pounds per cubic foot.

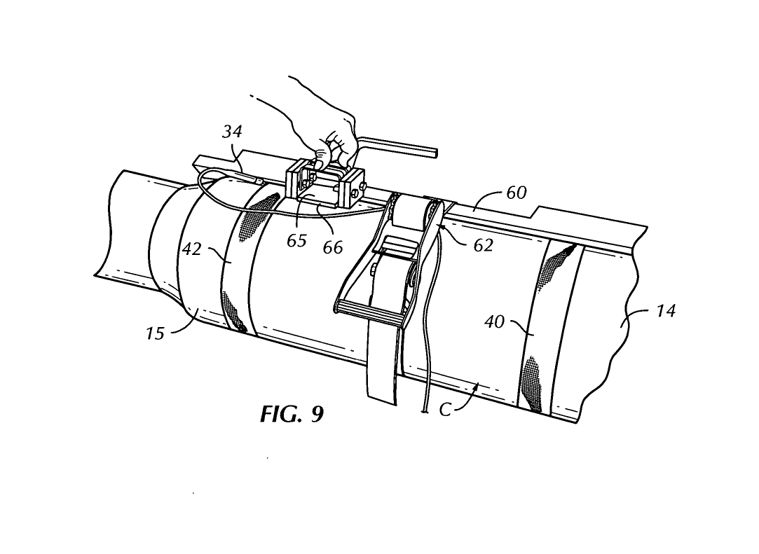

As shown in FIGS. 8 and 9, after injection of the solid polyurethane 55 to form the joint infill I, a longitudinal pressure pad 60 is installed on top of an area 62 of sleeve above the welding element/mesh 28 that creates the longitudinal section 28c of the weld on the suitable overlap of the sleeve C to itself. The pressure pad 60 is secured in place by means of a suitable mechanical clamping system 61, as shown in FIG. 8. If desired the clamping system may be automated in a manner similar to the air-impact wrench or hydraulic clamping systems described above or other types suitable for the circumferential welding.

An injection port closure 65 (FIG. 8) of comparable material to the sleeves and of a size to form a closure over the injection port 50 is used for closure purposes. The closure 65 is furnished with a conductive wire mesh backing 66 and is then installed over the injection port 50. A welding lead harness 68 is the applied over the closure 65. The harness 68 may be held in place by hand or a mechanical clamping system can be used. The mechanical clamping system may be of the same type as that for the circumferential clamping described above, such as either mechanical band straps operated with an air-impact wrench, hydraulic clamps adjustable by means of flow meters also to ensure consistent pressure, or the like.

An electrical power supply in the form of welding transformer or power supply P is then connected to the leads 32 and 34 and thus the welding mesh 28. Connections are also made to the wire welding mesh 66 with the injection port patch 65. Preferably, a separate power transformer or supply is used to provide current to the wire mesh 66 of the injection port closure 65 from that supplying the welding mesh 28. A separate power transformer or supply is thus preferably provided for each weld to be formed in the sleeve C.

The power supply P is a programmable one having a control unit or panel P. In the preferred embodiment, the power supply is a variable output transformer having a programmable output voltage of from 0 to 240 volts, and current levels from 0 to 100 or more amperes for programmable dwell times. The power supply P can thus be set to provide different current levels at different rates of current increase for adjustable periods of time. The current supply levels, current application times durations and other power supply parameters are thus adjustable, based on the particular type and size of weld to be formed in the cover sleeve C.

The power supply P is a variable output transformer and timer box used to deliver the electrical current to welding element/mesh 28 creating resistance heat. This transformer can be programmed at its control panel P to suit a wide range of parameters including programmable amount of power, adjustable speed to reach that amount of power, and programmable time to hold that power before returning to zero power. If desired, a thermocouple may be used to monitor the welding temperature and speed of temperature increase.

After connection to the respective power supplies, current flow is then turned on to reach a pre-determined amount of electrical power to the welding mesh 28 and the mesh 66 and at a pre-determined speed of increase for a pre-determined period of time. The materials of the cylindrical sleeve C bond together along the circumferential seams R and the longitudinal seam L where heat was applied by the element 28. In the embodiment shown, the heated synthetic resin becomes clear on melting so that the element 28 becomes visible. The interior surface 30 of the sleeve also bonds to the exterior of the infill I, and the outer portions of the sleeve C bond with the coated end portions 14 and 15, as well.

According to the present invention, a permanent outer cladding is formed by bonding of the synthetic resin materials together in the manner described above. The sleeve 30 bonds to the infill I and also to the factory applied portions 16 and 17 of the pipeline P. The infill I also bonds to the factory coated the sleeve 30 also bonds to synthetic resin in the coated portions 16 and 17. The sleeve 30 also bonds to itself along the area of the longitudinal overlap along edge portion 30b.

The joint in the pipeline P so formed is thus impermeable to water and in effect a hermetic seal. The joint formed according to the present invention provides an effective, water impermeable seal to the factory applied pipeline coatings and affords better protection for both the joint infill insulation and the pipeline insulation coatings.

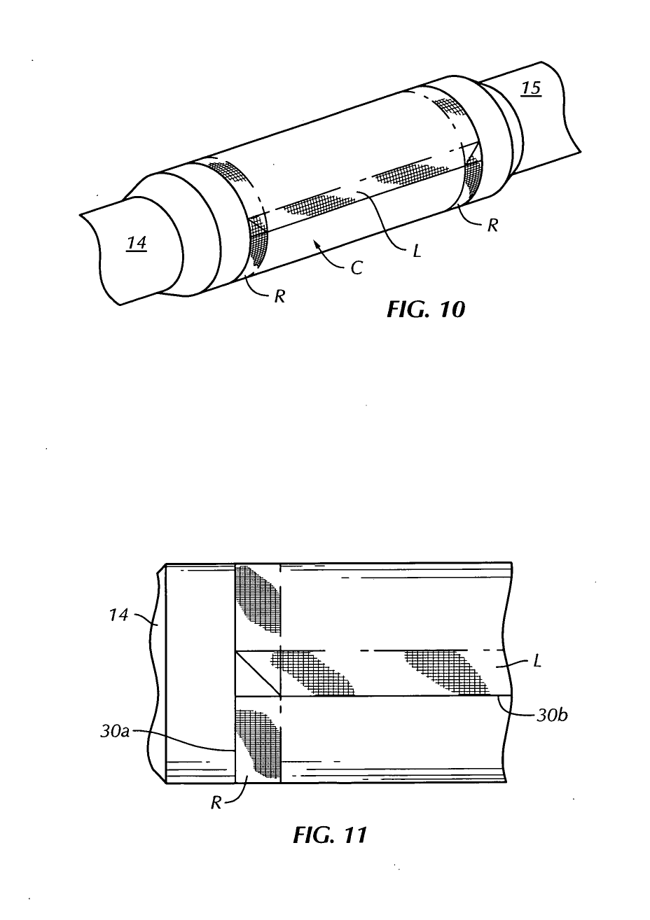

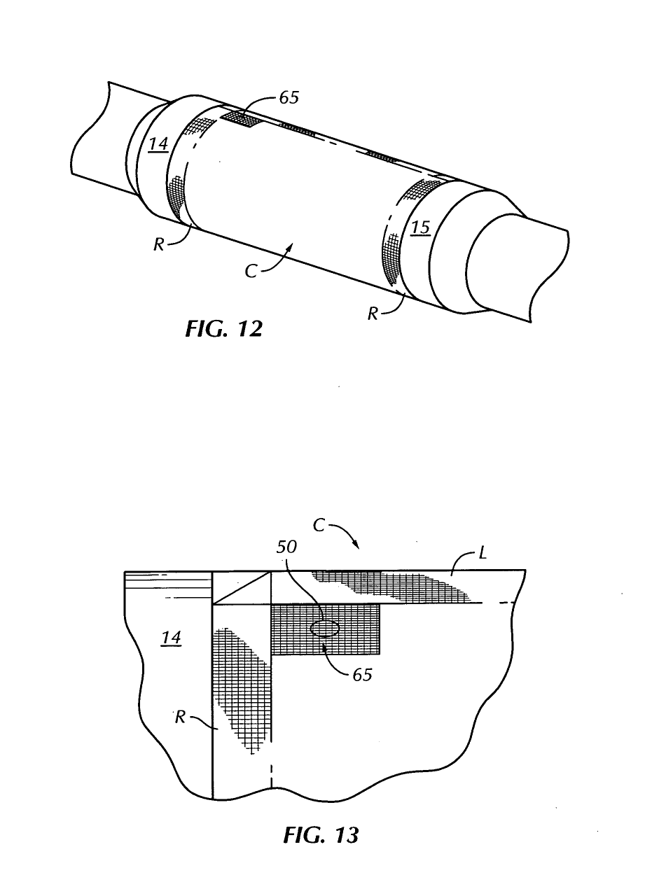

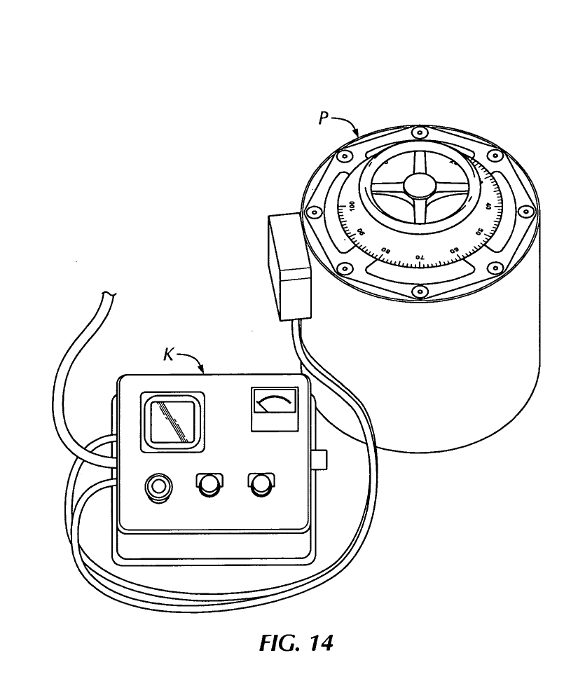

FIGS. 10, 11 12 and 13 show a finished joint infill shield according to the present invention. As shown in FIG. 10 the present invention forms the protective shield or cover sleeve C for the joint infill I. As disclosed above, no fluid path from the exterior of the sleeve C to the pipeline P is present within the infill. FIG. 11 shows the circumferential seal R formed at one end portion 30a and the longitudinal seal L formed along the edge portion 30b which form a circumferential and longitudinal weld and fluid seal about the gap G and infill I all together in a single unitary weld. FIG. 12 shows the weld formed injection port closure 65 and the circumferential seals R. FIG. 13 shows a portion of the structure of FIG. 12 with the injection port closure 65 adjacent one of the circumferential seals R and the longitudinal seal L.

The invention has been sufficiently described so that a person with average knowledge in the matter may reproduce and obtain the results mentioned in the invention herein Nonetheless, any skilled person in the field of technique, subject of the invention herein, may carry out modifications not described in the request herein, to apply these modifications to a determined structure, or in the manufacturing process of the same, requires the claimed matter in the following claims; such structures shall be covered within the scope of the invention.

It should be noted and understood that there can be improvements and modifications made of the present invention described in detail above without departing from the spirit or scope of the invention as set forth in the accompanying claims.

What is claimed is:

1. A method of applying protective cladding over welded end portions of coated sections of pipe for a pipeline, comprising the steps of:
applying a sheet of synthetic resin with an electrically conductive element about three sides to form a cylindrical sleeve about the welded end portions;
attaching the electrically conductive element to a source of electrical current;
introducing components into the interior of the cylindrical sleeve to allow a synthetic resin to form and fill the interior of the sleeve as joint infill between the adjacent pipe sections; and
sending electrical current into the electrically conductive element to heat adjacent portions of the cylindrical sleeve to bond together and seal the sleeve over the joint infill.

2. The method of claim 1, where the coated sections of pipe are insulation coated.

3. The method of claim 1, wherein the coated sections of pipe are weight-coated.

4. The method of claim 1, wherein the coated portions of the pipeline are coated with a synthetic resin coating.

5. The method of claim 4, wherein the synthetic resin formed during the step of introducing components bonds with the synthetic resin coating.

6. The method of claim 2, wherein the synthetic resin joint comprises a solid polyurethane.

7. The method of claim 2, wherein the synthetic resin joint infill comprises an epoxy.

8. The method of claim 2, further including the step of:
forming an opening into the synthetic resin sleeve for entry of the components.

9. The method of claim 8, further including the step of:
sealing the opening after the step of introducing components.

10. The method of claim 8, wherein the step of forming the opening in the synthetic resin sleeve is performed after the step of applying.

11. The method of claim 8, wherein the step of forming the opening in the synthetic resin sleeve is performed before the step of applying.

12. The method of claim 1, further including the step of:
securing the sleeve in place on the coated sections of pipe with the electrically conductive element attached.

13. The method of claim 1, wherein the step of applying the sheet comprises applying the sheet with a portion of the electrically conductive element extending longitudinally with respect to the pipeline.

14. The method of claim 1, wherein the step of applying the sheet comprises applying the sheet with a portion of the electrically conductive element extending circumferentially about adjacent weight coated sections at their welded end portions.

15. A protective cladding over welded end portions of adjacent synthetic resin coated sections of pipe for a pipeline, comprising:
a sheet of synthetic resin applied to form a sleeve extending circumferentially to define an annulus about the welded end portions;
an electrically conductive element extending continuously in a circumferential manner about the weight coated pipe sections adjacent the annulus and longitudinally within the sleeve along the end section, the conductive element heating the synthetic resin sleeve to seal the annulus about the cavity and bonding the synthetic resin sleeve with the synthetic resin weight-coated sections; and
a synthetic resin infill formed to fill the annulus within the sleeve by injecting components which reacts and forms a water impermeable infill.

16. The protective shield of claim 15, wherein the synthetic resin infill bonds with the synthetic resin sleeve.

17. The protective shield of claim 15, wherein the synthetic resin sleeve bonds with the coated sections.

18. The protective shield of claim 15, wherein the synthetic resin infill bonds with the synthetic resin coated sections.

19. The protective shield of claim 15, wherein the coated sections are insulated coated.

20. The protective shield of claim 15, wherein the coated sections are weight-coated.

21. The protective shield of claim 15, wherein the hard synthetic resin infill in the annulus comprises a hard polyurethane.

22. The protective shield of claim 15, wherein the hard synthetic resin infill in the annulus comprises an epoxy.
